(19) United States
(12) Patent Application Publication
(10) Pub. No.: US 2025/0189143 A1
(43) Pub. Date: Jun. 12, 2025

(54) HOT WATER SUPPLY SYSTEM CAPABLE OF HOT WATER PREHEATING AND MALFUNCTION DETERMINATION METHOD USING SAME

(71) Applicant: KYUNGDONG NAVIEN CO., LTD., Gyeonggi-do (KR)

(72) Inventors: Nam Soo DO, Seoul (KR); Si Hwan KIM, Seoul (KR); Chang Heoi HEO, Seoul (KR); Yong Min SONG, Seoul (KR)

(73) Assignee: KYUNGDONG NAVIEN CO., LTD., Gyeonggi-do (KR)

(21) Appl. No.: 18/841,098

(22) PCT Filed: Dec. 30, 2022
(86) PCT No.: PCT/KR2022/021689

§ 371 Date: Aug. 23, 2024

(30) Foreign Application Priority Data
Feb. 24, 2022 (KR) 10-2022-0024179
Feb. 24, 2022 (KR) 10-2022-0024180

(51) Int. Cl. F24D 17/00; F24D 19/10; F24H 15/104; F24H 15/219; F24H 15/238; F24H 15/325; F24H 15/335; F24H 15/395; F24H 15/421

(52) U.S. Cl. CPC F24D 17/0078; F24D 19/1051; F24H 15/104; F24H 15/219; F24H 15/238; F24H 15/325; F24H 15/335; F24H 15/395; F24H 15/421

(57) ABSTRACT

A hot water supply system according to the present invention comprises a boiler which heats water supplied from a direct water pipe to provide same to a hot water pipe and a hot water circulation valve which connects or separates the hot water pipe to or from the direct water pipe on the basis of a valve operation temperature, wherein a preheating time may be learned on the basis of a flow rate of water circulated through the hot water pipe, the hot water circulation valve, the direct water pipe, and the boiler when a preheating operation is performed, and a malfunction of the hot water circulation valve can be determined through flow rate detection without a separate device.

### TECHNICAL FIELD

The present disclosure relates to a hot water supply system for providing hot water preheated to an appropriate temperature to a user and an operating method using the same.

### BACKGROUND ART

A boiler is an apparatus that heats water using a heat source and provides the heated water for heating or discharges the heated water in the form of hot water. A burner that generates a large amount of heat depending on a combustion reaction of fuel and oxygen and provides heated water through a heat exchanger may be used as the heat source of the boiler.

Water heated in the boiler may be provided to a consumption site in a way that the water is discharged to the outside. In this case, in order to use hot water at a preset temperature, a user has to wait for the time it takes the hot water to reach the consumption site from the boiler. Meanwhile, direct water is discharged and discarded. As the distance between the consumption site and the boiler is increased, more direct water is discarded, and the user has to wait for a long time to use the hot water at the preset temperature.

### DISCLOSURE

### Technical Problem

An aspect of the present disclosure provides a hot water supply system for enabling a user to immediately use hot water at a preset temperature at a consumption site irrespective of the distance between the consumption site and a boiler.

Another aspect of the present disclosure provides a preheating time learning method using a hot water supply system and a malfunction determination method for determining a malfunction of a hot water circulation valve.

The technical problems to be solved by the present disclosure are not limited to the aforementioned problems, and any other technical problems not mentioned herein will be clearly understood from the following description by those skilled in the art to which the present disclosure pertains. Also, it will be easily understood that the aspects and advantages of the present disclosure are able to be accomplished by the means set forth in the appended claims and combinations thereof.

### Technical Solution

According to an embodiment of the present disclosure, a hot water supply system includes a boiler that heats water supplied from a direct water pipe and provides the heated water to a hot water pipe and a hot water circulation valve that connects or separates the hot water pipe and the direct water pipe based on a valve operation temperature. The hot water supply system performs at least one of an operation of learning preheating time based on a flow rate of water circulating through the hot water pipe, the hot water circulation valve, the direct water pipe, and the boiler during a preheating operation, an operation of changing preheating pause time based on a difference between a temperature of the water circulating through the hot water pipe, the hot water circulation valve, the direct water pipe, and the boiler at the end of the preheating operation and a temperature of the circulating water at the start of the preheating operation, or a combination of the operations.

According to an embodiment, the hot water supply system may further include a hot water supply management device that performs at least one of an operation of learning the preheating time based on the flow rate of the water circulating through the hot water pipe, the hot water circulation valve, the direct water pipe, and the boiler during the preheating operation and determining a malfunction of the hot water circulation valve based on the learned preheating time, an operation of calculating a difference between a temperature of water in the direct water pipe at the end of the preheating operation and a temperature of the water in the direct water pipe at the start of the preheating operation, changing the preheating pause time by comparing the calculated temperature difference with a preset range, and determining a failure in the hot water circulation valve based on a flow rate in the direct water pipe during the preheating operation to which the changed preheating pause time is applied, or a combination of the operations.

According to an embodiment, the hot water supply management device may include a flow sensor that senses the flow rate of the water circulating through the hot water pipe, the hot water circulation valve, the direct water pipe, and the boiler during the preheating operation and a malfunction determination device that detects and determines a malfunction of the hot water circulation valve based on preheating operation time information and flow rate information of the flow sensor.

According to an embodiment, the hot water supply management device may further include a preheating time learning device that learns the preheating time based on the valve operation temperature, preheating stop temperature, and the flow rate information and a controller that generates the preheating operation time information based on the learned preheating time and provides an error notification depending on the detection of the malfunction by the malfunction determination device.

According to an embodiment, the preheating time learning device may learn the preheating time based on the flow rate information of the flow sensor when the preheating stop temperature is higher than the valve operation temperature.

According to an embodiment, the preheating time learning device may start a count of the preheating time when the flow rate is detected based on the flow rate information during the preheating operation, may stop the count when the flow rate is not detected, and may store count values when the count is stopped.

According to an embodiment, the preheating time learning device may calculate a moving average of the stored count values and may learn the calculated value as the preheating time.

According to an embodiment, the preheating time learning device may initialize the started count when a current flow rate based on the flow rate information exceeds a preset flow rate after the count of the preheating time starts during the preheating operation.

According to an embodiment, the malfunction determination device may determine that the preheating operation ends, based on the preheating operation time information and may determine a malfunction of the hot water circulation valve when a current flow rate is detected based on the flow rate information even after the preheating operation ends and a preset period of time elapses.

According to an embodiment, the hot water supply management device may further include a temperature sensor that senses the temperature of the water circulating through the hot water pipe, the hot water circulation valve, the direct water pipe, and the boiler, a preheating pause time learning device that learns the preheating pause time based on temperature information of the temperature sensor, and a controller that generates the preheating operation time information based on the learned preheating pause time and provides an error notification depending on the detection of the malfunction by the malfunction determination device.

According to an embodiment, the preheating pause time learning device may calculate the difference between the temperature of the water in the direct water pipe at the end of the preheating operation and the temperature of the water in the direct water pipe at the start of the preheating operation and may decrease the preheating pause time by a preset time when the calculated temperature difference exceeds an upper limit of the preset range.

According to an embodiment, the preheating pause time learning device may calculate the difference between the temperature of the water in the direct water pipe at the end of the preheating operation and the temperature of the water in the direct water pipe at the start of the preheating operation and may increase the preheating pause time by a preset time when the calculated temperature difference is less than a lower limit of the preset range.

According to an embodiment, the preheating pause time learning device may calculate the difference between the temperature of the water in the direct water pipe at the end of the preheating operation and the temperature of the water in the direct water pipe at the start of the preheating operation and may maintain the preheating pause time when the calculated temperature difference is within the preset range.

According to an embodiment, the malfunction determination device may determine that the preheating operation starts, based on the preheating operation time information and may determine a malfunction of the hot water circulation valve when a current flow rate is detected based on the flow rate information even after the preheating operation ends and a preset period of time elapses.

According to an embodiment of the present disclosure, a method for operating a hot water supply system includes identifying a request for preheating, operating a circulation pump, detecting a flow rate of a hot water circulation path, starting a count and storing the detected flow rate when the circulation pump is operated and the flow rate of the hot water circulation path is detected, stopping the started count and storing count values when the flow rate of the hot water circulation path is not detected, and calculating a moving average of the stored count values and learning the calculated moving average as preheating time. The hot water circulation path is a path along which heated water from a boiler is circulated back to the boiler through a hot water pipe, a hot water circulation valve, and a direct water pipe.

According to an embodiment, the method may further include determining that a user uses hot water and initializing the started count when a currently-detected flow rate exceeds a preset flow rate.

According to an embodiment, the method may further include notifying a user of a failure in the hot water circulation valve when the flow rate of the hot water circulation path is detected even after the learned preheating time and a preset period of time elapse.

According to an embodiment of the present disclosure, a method for operating a hot water supply system includes identifying a request for preheating, operating a circulation pump, detecting and storing a temperature of water in a hot water circulation path, calculating a difference between a temperature of water in the hot water circulation path at the end of a preheating operation and a temperature of water in the hot water circulation path at the start of the preheating operation, and changing preheating pause time by comparing the calculated water temperature difference with a preset range. The hot water circulation path is a path along which heated water from a boiler is circulated back to the boiler through a hot water pipe, a hot water circulation valve, and a direct water pipe.

According to an embodiment, the changing of the preheating pause time may include decreasing the preheating pause time by a preset time when the calculated water temperature difference exceeds an upper limit of the preset range, increasing the preheating pause time by the preset time when the calculated water temperature difference is less than a lower limit of the preset range, and maintaining the preheating pause time when the calculated water temperature difference is within the preset range.

According to an embodiment, the method may further include determining a failure in the hot water circulation valve when a flow rate of the hot water circulation path is not detected even after a preset period of time elapses after start timing of preheating operation time to which the changed preheating pause time is applied.

### Advantageous Effects

The hot water supply system according to the embodiment of the present disclosure enables the user to directly receive the hot water at the temperature set by the user from the consumption site, thereby improving the user's satisfaction with the use of the hot water.

In addition, the malfunction determination method using the hot water supply system according to the embodiment of the present disclosure may determine a malfunction in the hot water circulation valve without a separate device, thereby improving reliability without increasing the installation cost of the hot water supply system.

### DESCRIPTION OF DRAWINGS

FIG. 1 is a schematic view illustrating a configuration of a hot water supply system according to one embodiment of the present disclosure.

FIG. 2 is a schematic view illustrating a configuration of a boiler included in the hot water supply system according to one embodiment of the present disclosure.

FIG. 3 illustrates graphs for explaining a hot water preheating operation of the hot water supply system according to one embodiment of the present disclosure.

FIG. 4 is a schematic view illustrating a configuration of a hot water supply management device included in the hot water supply system according to one embodiment of the present disclosure.

FIG. 5 illustrates graphs for explaining an operation of the hot water supply management device included in the hot water supply system according to one embodiment of the present disclosure.

FIG. 6 is a flowchart for explaining an operation of the hot water supply system according to one embodiment of the present disclosure.

FIG. 7 is a flowchart for explaining an operation of the hot water supply system according to another embodiment of the present disclosure.

### MODE FOR INVENTION

The aspects, features, and advantages described above will be described in detail with reference to the accompanying drawings. Accordingly, those skilled in the art to which the present disclosure pertains are able to easily carry out the spirit of the present disclosure. In describing the present disclosure, detailed descriptions of well-known technologies related to the present disclosure will be omitted when they may make subject matters of the present disclosure obscure. Hereinafter, embodiments of the present disclosure will be described in detail with reference to the accompanying drawings. In the drawings, the same reference numerals are used to indicate the same or similar components.

Hereinafter, when any component is referred to as being disposed “on (or, under)” or “above (or, below)” a component, it may mean not only that any component is disposed on the upper surface (or, the lower surface) of the component, but also that another component is interposed between the component and any component disposed above (or, below) the component.

When a component is described as being “connected”, “coupled”, or “linked” to another component, this may mean not only that the components are directly “connected”, “coupled”, or “linked” with each other, but also that another component is “interposed” between the components or the components are “connected”, “coupled”, or “linked” with each other through another component.

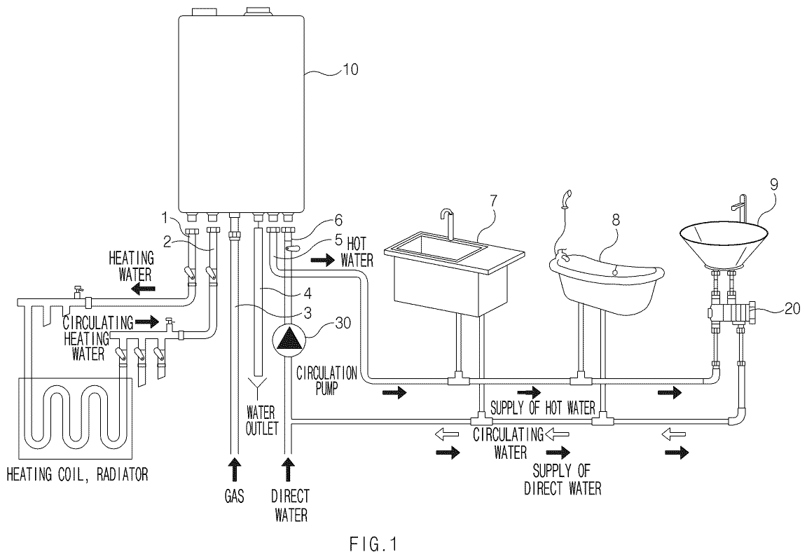

FIG. 1 is a schematic view illustrating a configuration of a hot water supply system according to one embodiment of the present disclosure.

Referring to FIG. 1, the hot water supply system according to one embodiment of the present disclosure may include a boiler 10, a hot water circulation valve 20, and a circulation pump 30.

The boiler 10 may be connected to a heating water supply pipe 1, a circulating heating water pipe 2, a gas pipe 3, a drain pipe 4, a hot water pipe 5, and a direct water pipe 6.

The boiler 10 may receive gas from the gas pipe 3 and may heat water to generate heating water and hot water at a set temperature. Although the gas is described as an example of the fuel of the boiler 10, the present disclosure is not limited thereto.

The boiler 10 may supply the heating water at the set temperature to a heating consumption site (a heating coil or a radiator) by supplying the heated water to the heating water supply pipe 1 as the heating water. In addition, the heating water, the temperature of which is lowered via the heating consumption site may be provided as circulating heating water to the boiler 10 through the circulating heating water pipe 2, and the boiler 10 may heat the circulating heating water and may supply the heated circulating heating water to the heating water supply pipe 1 as heating water.

As a result, the boiler 10 may circulate the heating water at a temperature corresponding to the temperature set by a user through the heating water supply pipe 1, the heating consumption side, and the circulating heating water pipe 2 and thus may maintain the temperature of the heating consumption site set by the user.

The boiler 10 may discharge water circulating inside the boiler 10 through the drain pipe 4. For example, the boiler 10 may discharge the heating water circulating via the heating consumption site through the drain pipe 4.

The boiler 10 may supply the hot water at the set temperature to hot water consumption sites 7, 8, and 9 by supplying the heated water to the hot water pipe 5 as the hot water. For example, the hot water consumption sites 7, 8, 9 may include faucets in places where the hot water is used, such as a sink 7, a bathtub 8, and a washbasin 9.

Although it has been described that the hot water supply system according to one embodiment of the present disclosure includes the boiler 10 that provides the heated water to the heating consumption site and the hot water consumption sites 7, 8, and 9, the hot water supply system may include a water heater that provides heated water only to the hot water consumption sites 7, 8, and 9.

The boiler 10 and the hot water consumption sites 7, 8, and 9 may be connected to the direct water pipe 6 and may receive direct water from the direct water pipe 6.

The hot water circulation valve 20 may be disposed between the hot water pipe 5 and the direct water pipe 6 that are connected with the hot water consumption sites 7, 8, and 9.

The hot water circulation valve 20 may physically connect (OPEN) the hot water pipe 5 and the direct water pipe 6 when the hot water in the hot water pipe 5 is below a preset temperature (a valve operation temperature) and may physically separate the hot water pipe 5 and the direct water pipe 6 when the hot water in the hot water pipe 5 is above the preset temperature (the valve operation temperature). Although the hot water circulation valve 20 is described as being disposed at a distal consumption site among the hot water consumption sites 7, 8, and 9, that is, the washbasin 9, the position of the hot water circulation valve 20 is not limited thereto. The hot water circulation valve 20 may include a crossover valve.

For example, when the hot water in the hot water pipe 5 is below the preset temperature, the hot water circulation valve 20 may connect the hot water pipe 5 and the direct water pipe 6 to cause the hot water in the hot water pipe 5 to flow to the direct water pipe 6.

Meanwhile, when the hot water in the hot water pipe 5 is above the preset temperature, the hot water circulation valve 20 may separate the hot water pipe 5 and the direct water pipe 6 from each other to stop the hot water in the hot water pipe 5 from flowing to the direct water pipe 6.

The circulation pump 30 may form direct water pressure and may supply the direct water to the boiler 10 through the direct water pipe 6. In addition, the circulation pump 30 may adjust the flow rate of direct water supplied to the boiler 10 and may cause the heated water (hot water) from the boiler 10 to return to the boiler 10.

Likewise to a general hot water supply system, the above-configured hot water supply system according to one embodiment of the present disclosure may perform a hot water control operation of providing the hot water at the set temperature to the hot water consumption sites when the user uses the hot water.

The hot water supply system according to one embodiment of the present disclosure may perform a preheating control operation of performing control to circulate the hot water obtained by heating the direct water through the hot water pipe 5, the hot water circulation valve 20, and the direct water pipe 6 before the hot water usage time set by the user or before the time the hot water is expected to be used.

Through the preheating control operation of the hot water supply system according to one embodiment of the present disclosure, the user may immediately use the hot water at the set temperature when using the hot water at the hot water consumption sites, and thus the user's satisfaction with the use of the hot water may be improved.

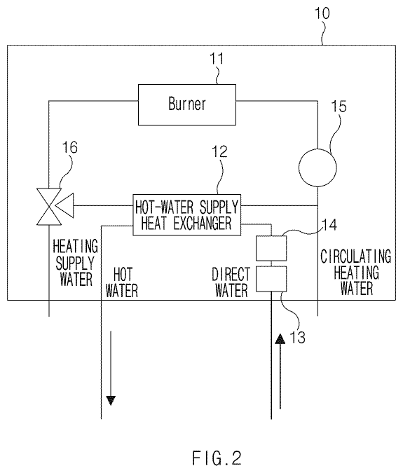

FIG. 2 is a schematic view illustrating a configuration of the boiler included in the hot water supply system according to one embodiment of the present disclosure.

Referring to FIG. 2, the boiler 10 may include a burner 11, a hot-water supply heat exchanger 12, a temperature sensor 13, a flow sensor 14, a pump 15, and a 3-way valve 16.

The burner 11 may heat the circulating heating water supplied from the pump 15 and may supply warmed water to the 3-way valve 16.

The hot-water supply heat exchanger 12 may heat the direct water supplied from the direct water pipe 6 and may supply the heated direct water to the hot water pipe 5 as the hot water.

The temperature and flow rate of the direct water supplied from the direct water pipe 6 to the hot-water supply heat exchanger 12 may be sensed by the temperature sensor 13 and the flow sensor 14 installed in the direct water pipe 6.

The pump 15 may provide the circulating heating water returning to the circulating heating water pipe 2 via the heating consumption site to the burner 11.

The 3-way valve 16 may perform control such that the water heated by the burner 11 is provided to the heating pipe 1 as the heating water or provided to the pump 15 via the hot-water supply heat exchanger 12.

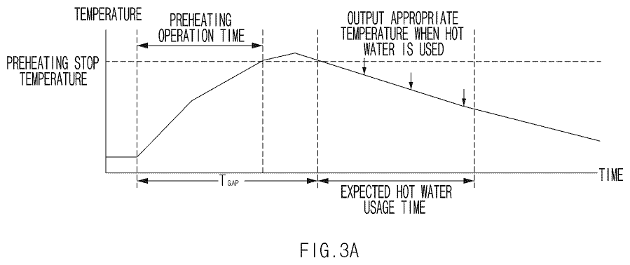

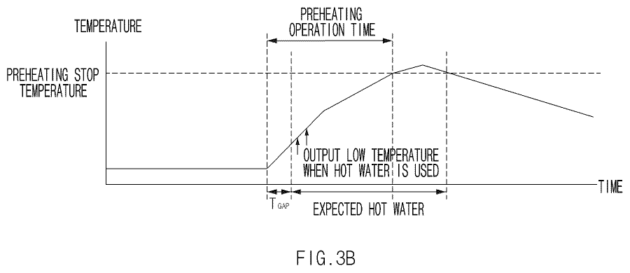

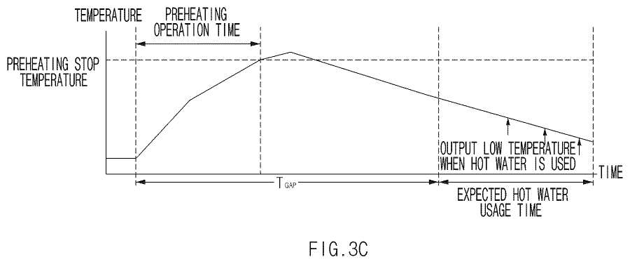

FIG. 3 illustrates graphs for explaining a hot water preheating operation of the hot water supply system according to one embodiment of the present disclosure.

FIG. 3(A) illustrates normal preheating operation time and normal expected hot water usage time.

Referring to FIG. 1, the boiler 10 may heat the water circulating through the hot water pipe 5, the hot water circulation valve 20, and the direct water pipe 6 through a preheating control operation during the preheating operation time.

Through the preheating control operation, the boiler 10 may raise the temperature of the hot water provided to the hot water consumption site from the hot water pipe 5 before the time the user is expected to use the hot water, and thus when the user uses the hot water at the expected hot water usage time, the user may immediately use the hot water at the set temperature without discarding cold water in the hot water pipe 5.

FIGS. 3(B) and (C) illustrate cases in which the preheating operation time is abnormally determined.

FIG. 3(B) illustrates a case in which the preheating operation time overlaps the expected hot water usage time.

The hot water supplied from the hot water pipe 5 to the hot water consumption site may be less warmed, and when the user uses the hot water at the expected hot water usage time, the user may use cold water.

FIG. 3(C) illustrates a case in which the time difference between the preheating operation time and the expected hot water usage time is too large.

The hot water supplied from the hot water pipe 5 to the hot water consumption site may be heated during the preheating operation time and may reach a preheating stop temperature. However, since the time difference between the preheating operation time and the expected hot water usage time is too large, the user may use cold water when the user uses the hot water at the expected hot water usage time.

To improve the user's satisfaction with the use of the hot water by allowing the user to immediately use the hot water at the set temperature without using cold water in the hot water pipe 5 when the user uses the hot water at the expected hot water usage time, the preheating operation time and the expected hot water usage time have to be determined as in FIG. 3(A).

Accordingly, to improve the user's satisfaction with the use of the hot water, accurate preheating operation time has to be learned.

General preheating operation time may be the time that the temperature of the hot water circulating through the hot water pipe 5, the hot water circulation valve 20, and the direct water pipe 6 reaches the preheating stop temperature.

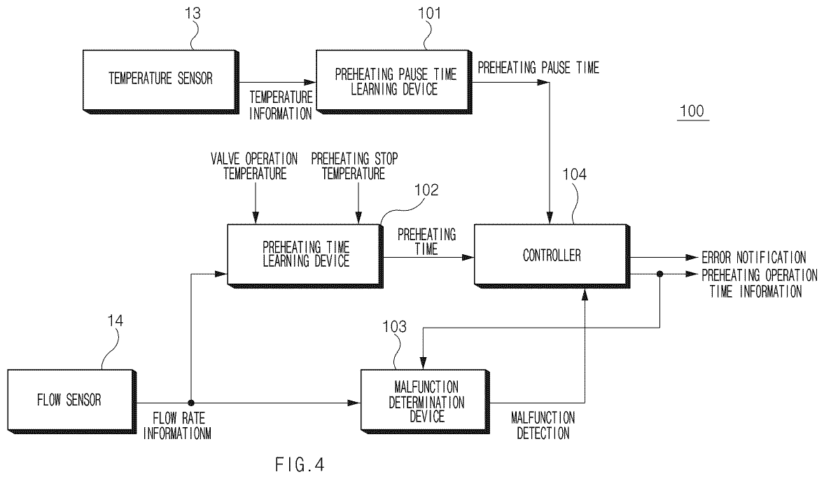

FIG. 4 is a schematic view illustrating a configuration of a hot water supply management device included in the hot water supply system according to one embodiment of the present disclosure.

Referring to FIG. 4, the hot water supply management device 100 may include the temperature sensor 13, the flow sensor 14, a preheating pause time learning device 101, a preheating time learning device 102, a malfunction determination device 103, and a controller 104.

The temperature sensor 13 may sense the temperature of the hot water circulating through the hot water pipe 5, the hot water circulation valve 20, and the direct water pipe 6.

The flow sensor 14 may sense the flow rate of the hot water circulating through the hot water pipe 5, the hot water circulation valve 20, and the direct water pipe 6.

As illustrated in FIG. 2, the temperature sensor 13 and the flow sensor 14 may be installed in the direct water pipe 6. Alternatively, since the temperature sensor 13 and the flow sensor 14 measure the temperature and flow rate of the hot water circulating through the hot water pipe 5, the hot water circulation valve 20, and the direct water pipe 6, the temperature sensor 13 and the flow sensor 14 may also be installed in the hot water pipe 5.

The preheating pause time learning device 101 may receive temperature information from the temperature sensor 13.

For example, the preheating pause time learning device 101 may store the temperature information provided from the temperature sensor 13 when the preheating operation time ends and may store the temperature information provided from the temperature sensor 13 when the preheating operation time starts.

In addition, the preheating pause time learning device 101 may increase, decrease, or maintain preheating pause time based on the difference between the temperature stored when the preheating operation time ends and the temperature stored when the preheating operation time starts.

For example, when the difference between the temperature stored when the preheating operation time ends and the temperature stored when the preheating operation time starts is within a preset range, the preheating pause time learning device 101 may maintain the preheating pause time.

When the difference between the temperature stored when the preheating operation time ends and the temperature stored when the preheating operation time starts exceeds the upper limit of the preset range, the preheating pause time learning device 101 may decrease the preheating pause time by a preset time (e.g., 1 minute).

When the difference between the temperature stored when the preheating operation time ends and the temperature stored when the preheating operation time starts is less than the lower limit of the preset range, the preheating pause time learning device 101 may increase the preheating pause time by the preset time (e.g., 1 minute).

The preheating time learning device 102 may receive temperature information and flow rate information of the hot water from the temperature sensor 13 and the flow sensor 14.

The preheating time learning device 102 may learn preheating time based on the temperature information, the flow rate information, the valve operation temperature, and the preheating stop temperature.

For example, when the valve operation temperature is lower than the preheating stop temperature, the preheating time learning device 102 may learn the preheating time based on the temperature information and the flow rate information.

Meanwhile, when the valve operation temperature is higher than the preheating stop temperature, the preheating time learning device 102 may stop learning the preheating time.

The valve operation temperature may be a temperature at which the hot water circulation valve 20 connects or separates the hot water pipe 5 and the direct water pipe 6, and the preheating stop temperature may be a temperature having a temperature value corresponding to the temperature of the hot water set by the user.

That is, only when the preheating stop temperature corresponding to the temperature of the hot water set by the user is higher than the valve operation temperature, the preheating time learning device 102 may learn the preheating time based on the temperature information and the flow rate information of the hot water.

Hereinafter, the case in which the preheating stop temperature is higher than the valve operation temperature will be described.

The preheating time learning device 102 may start a count of the preheating time when the flow rate of the hot water circulating through the hot water pipe 5, the hot water circulation valve 20, and the direct water pipe 6 is detected based on the flow rate information.

In addition, when the temperature of the circulating hot water reaches the preheating stop temperature or the flow rate of the circulating hot water is not detected for a preset period of time after the preheating time learning device 102 starts the count of the preheating time, the preheating time learning device 102 may stop the count of the preheating time.

The preheating time learning device 102 may store the count value of the preheating time (from start to stop) a preset number of times, may calculate the moving average of the stored count values of the preheating time (e.g., five count values recently stored), and may provide the calculated value to the controller 104 as the preheating time.

For example, when the flow rate of the hot water circulating through the hot water pipe 5, the hot water circulation valve 20, and the direct water pipe 6 is detected, the preheating time learning unit 102 may start the count, and when the flow rate of the circulating hot water is not detected for a preset period of time, the preheating time learning device 102 may stop the count, may calculate the average value of the last five count values, and may provide the calculated value to the controller 104 as the preheating time.

The malfunction determination device 103 may receive preheating operation time information from the controller 104 and may determine a failure (or, error or malfunction) in the hot water circulation valve 20, based on the preheating operation start timing and the flow rate information from the flow sensor 14.

For example, when a flow rate is not detected in the hot water circulation path (the path including the hot water pipe 5, the hot water circulation valve 20, and the direct water pipe 6) until a preset period of time (e.g., 5 seconds) elapses from the preheating operation start timing, the malfunction determination device 103 may determine that the hot water circulation valve 20 fails.

When the flow rate of the circulating hot water is detected even after the preheating operation control is terminated based on the preheating operation time information and a preset period of time elapses, the malfunction determination device 103 may determine that a malfunction of the hot water circulation valve is detected.

When it is determined that the hot water circulation valve 20 fails (malfunctions), the malfunction determination device 103 may provide, to the controller 104, information that the malfunction in the hot water circulation valve 20 is detected.

The controller 104 may receive the preheating pause time from the preheating pause time learning device 101 and may generate preheating operation time information.

For example, when the preheating pause time elapses after the preheating operation ends, the controller 104 may generate preheating operation time information including the timing of starting the next preheating operation.

The controller 104 may receive the preheating time from the preheating time learning device 102 and may generate preheating operation time information. The preheating operation time information may include the preheating operation time illustrated in FIG. 3(A). Accordingly, based on the preheating time provided from the preheating time learning device 102, the controller 104 may determine how far in advance of the expected hot water usage time the preheating operation control is performed and may determine the time difference between the preheating operation time and the expected hot water usage time.

In addition, when the controller 104 receives, from the malfunction determination device 103, information that a malfunction is detected, the controller 104 may provide an error notification to the user. The controller 104 may notify the user of the malfunction in the hot water circulation valve 20 through a display or speaker.

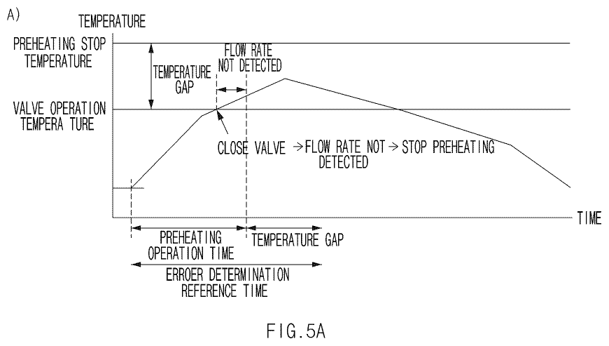

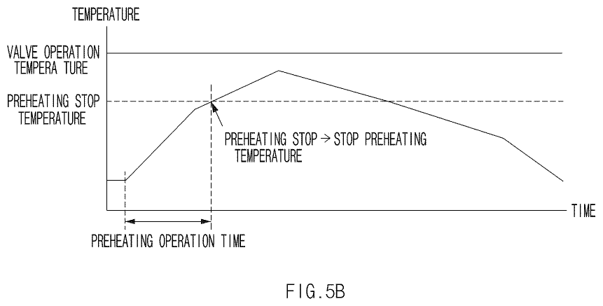

FIG. 5 illustrates graphs for explaining an operation of the hot water supply management device included in the hot water supply system according to one embodiment of the present disclosure.

FIG. 5(A) is a graph depicting a case in which the preheating time learning device 102 of FIG. 4 learns the preheating time (a case in which the preheating stop temperature is higher than the valve operation temperature), and FIG. 5(B) is a graph depicting a case in which the preheating time learning device 102 of FIG. 4 does not learn the preheating time (a case in which the preheating stop temperature is lower than the valve operation temperature).

In the case in which the valve operation temperature is lower than the preheating stop temperature as in FIG. 5(A), when the preheating operation time comes, the circulation pump 30 may operate such that the hot water from the boiler 10 is circulated back to the boiler 10 through the hot water pipe 5, the hot water circulation valve 20, and the direct water pipe 6. At this time, the boiler 10 may reheat the hot water circulated through the direct water pipe 6, and thus the temperature of the hot water circulated back to the boiler 10 through the hot water pipe 5, the hot water circulation valve 20, and the direct water pipe 6 may be consistently raised.

When the circulation pump 30 operates and the circulation flow rate of the hot water is detected, a count of the preheating time may start.

When the temperature of the circulating hot water is higher than the valve operation temperature, the hot water circulation valve 20 may physically separate the hot water pipe 5 and the direct water pipe 6 to block the hot water from being circulated.

When the circulation of the hot water is blocked, the flow sensor 14 may fail to sense the flow rate, and when the flow rate is not detected from the flow sensor 14 for a preset period of time (e.g., 30 seconds), the count of the preheating time may be stopped.

The preheating time learning device 102 may store count values, may calculate the average of a preset number of count values recently stored, and may provide the calculated average value to the controller 104 as the preheating time.

The controller 104 may determine the preheating operation time based on the preheating time provided from the preheating time learning device 102 and the user's expected hot water usage time.

The malfunction determination device 103 may determine a malfunction of the hot water circulation value 20 based on the preheating operation time information provided from the controller 104 and the flow rate of the circulating hot water provided from the flow sensor 14.

For example, even when the preheating operation time ends and a preset period of time (a time GAP) elapses, if the flow rate is detected from the flow sensor 14, the malfunction determination device 103 may determine a malfunction (failure) in the hot water circulation valve 20 and may provide the determined information (the detection of the malfunction) to the controller 104.

FIG. 5(B) illustrates a preheating control operation when the preheating stop temperature is lower than the valve operation temperature, and the preheating time learning device 102 of FIG. 4 does not learn the preheating time illustrated in FIG. 5(B), that is, the time during which the preheating control operation is performed.

The boiler 10 may raise the temperature of the circulating hot water to the preheating stop temperature, and when the temperature of the circulating hot water reaches the preheating stop temperature, the boiler 10 may stop heating (preheating) the hot water.

When the user does not use the hot water at the expected hot water usage time after the first preheating operation is performed in the hot water supply system according to another embodiment of the present disclosure, the preheating operation may start again after the preheating pause time elapses.

As illustrated in FIG. 5(C), in the hot water supply system according to one embodiment of the present disclosure, the preheating operation control may repeat an operation of one cycle divided into the preheating operation time and the preheating pause time until the user uses the hot water or for a preset period.

When the preheating operation time and the preheating pause time are repeated, the start timing of the next preheating operation time may vary depending on the preheating pause time, and therefore it may be important to learn the exact preheating pause time.

The preheating operation time may mean the time during which water to be heated by the boiler 10 is circulated along the hot water circulation path via the boiler 10, the hot water pipe 5, the hot water circulation valve 20, and the direct water pipe 6.

The preheating pause time may mean the time during which the hot water circulation path is blocked by the hot water circulation valve 20 and water is not heated by the boiler 10, and during the preheating pause time, the temperature of the water in the hot water pipe 5 may be lowered.

The preheating pause time learning device 101 of FIG. 4 may store the water temperature of the hot water circulation path (e.g., the water temperature of the direct water pipe 6) at the time point when the preheating operation time ends and may store the water temperature of the hot water circulation path at the time point when the preheating operation time starts (e.g., the time point when a preset period of time (5 seconds) elapses after the circulation pump 30 is operated).

In addition, the preheating pause time learning device 101 may calculate the difference between the water temperature stored at the time point when the preheating operation time ends and the water temperature at the time point when the preheating operation time starts, and when the calculated water temperature difference is within a preset range, the preheating pause time learning device 101 may maintain the previous preheating pause time.

When the calculated water temperature difference exceeds the upper limit of the preset range, the preheating pause time learning device 101 may decrease a preset period of time (e.g., one minute) from the previous preheating pause time.

When the calculated water temperature difference is less than the lower limit of the preset range, the preheating pause time learning device 101 may increase the preset period of time (e.g., one minute) from the previous preheating pause time.

As a result, the preheating pause time learning device 101 may change the preheating pause time by a preset period of time based on the difference between the water temperature stored at the time point when the preheating operation time ends and the water temperature at the time point when the preheating operation time starts. The changed preheating pause time may be applied when the next preheating operation ends.

The preheating pause time learning device 101 included in the hot water supply system according to one embodiment of the present disclosure may calculate the difference between the temperature at the time point when the preheating ends and the temperature at the time point when the preheating starts, may maintain the preheating pause time when the calculated temperature difference is within a preset range, and may increase or decrease the preheating pause time when the calculated temperature difference exceeds the upper limit of the preset range or is less than the lower limit of the preset range.

In other words, the hot water supply system according to one embodiment of the present disclosure may repeat the preheating operation and the preheating pause operation and may maintain the water temperature of the hot water circulation path within a certain range.

When the preheating pause time is too long, the water temperature difference of the hot water circulation path may be increased, and therefore the user's satisfaction with the use of the hot water may be lowered. When the preheating pause time is too short, the preheating operation may be frequently performed, and therefore efficiency may be lowered.

Accordingly, the hot water supply system according to one embodiment of the present disclosure may maintain the water temperature of the hot water circulation path within a certain range, thereby increasing the user's satisfaction with the use of the hot water and the efficiency of the preheating operation.

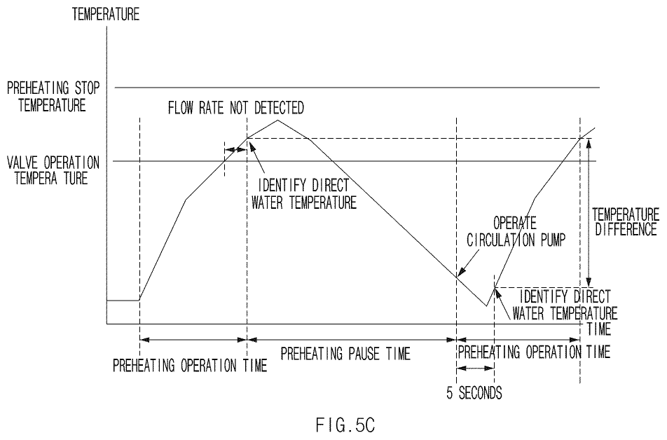

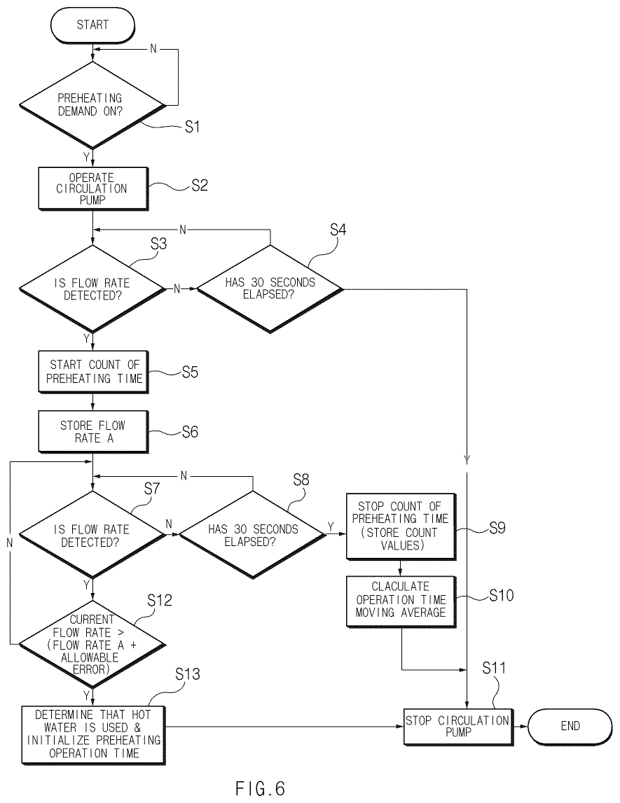

FIG. 6 is a flowchart for explaining an operation of the hot water supply system according to one embodiment of the present disclosure.

In particular, FIG. 6 is for explaining a preheating time learning method and a malfunction determination method using the hot water supply system according to one embodiment of the present disclosure.

Referring to FIG. 6, the preheating time learning method using the hot water supply system according to one embodiment of the present disclosure may include a preheating request identification step S1, a circulation pump operation step S2, a first flow-rate detection determination step S3, a first time elapsing determination step S4, a count start step S5, a flow-rate storage step S6, a second flow-rate detection determination step S7, a second time elapsing determination step S8, a count stop step S9, a moving average calculation step S10, a circulation pump stop step S11, a flow-rate determination step S12, and a count initialization step S13.

The preheating request identification step S1 may include a step of determining whether preheating is requested.

When it is determined in the preheating request identification step S1 that the preheating is requested (Y), the circulation pump operation step S2 may be performed.

When it is determined in the preheating request identification step S1 that the preheating is not requested (N), the preheating request identification step S1 may be performed until a request for preheating is identified.

The circulation pump operation step S2 may include a step of operating the circulation pump 30. The heated water (hot water) from the boiler 10 may be circulated back to the boiler 10 through the hot water pipe 5, the hot water circulation valve 20, and the direct water pipe 6. That is, when it is determined that the preheating is requested, the boiler 10 may heat water and may output the heated water to the hot water pipe 10, and the heated water (hot water) may be provided to the direct water pipe 6 through the hot water pipe 10 and the hot water circulation valve 20 and may be circulated back to the boiler 10 through the direct water pipe 6. In the preheating operation control, the hot water may be circulated along the circulation path constituted by the hot water pipe 5, the hot water circulation valve 20, and the direct water pipe 6. Since the temperature of the hot water reaching the hot water circulation valve 20 from the hot water pipe 5 is lower than or equal to the valve operation temperature immediately after the circulation pump operation step S2 is performed, the hot water circulation valve 20 may be in a state of physically connecting the hot water pipe 5 and the direct water pipe 6.

The first flow-rate detection determination step S3 may include a step of detecting and identifying the flow rate of the hot water circulation path in the preheating operation that includes the hot water pipe 5, the hot water circulation valve 20, and the direct water pipe 6.

When it is determined in the first flow-rate detection determination step S3 that the flow rate of the hot water circulation path in the preheating operation is detected and the hot water circulation path is formed (Y), the count start step S5 may be performed.

Meanwhile, when it is determined in the first flow-rate detection determination step S3 that the flow rate of the hot water circulation path in the preheating operation is not detected and the hot water circulation path is not formed (N), the first time elapsing determination step S4 may be performed.

The first time elapsing determination step S4 may include a step of determining whether the flow rate of the hot water circulation path in the preheating operation is detected for a preset period of time (e.g., 30 seconds).

When it is determined in the first time elapsing determination step S4 that the flow rate of the hot water circulation path in the preheating operation is not detected for the preset period of time (N), the circulation pump stop step S11 may be performed. In this case, the temperature of the hot water reaching the hot water circulation valve 20 through the hot water pipe 5 may be higher than the valve operation temperature. The circulation pump 30 may be stopped, and the preheating operation may be terminated.

When it is determined in the first time elapsing determination step S4 that the flow rate is detected before the preset period of time elapses (N), the count start step S5 may be performed via the first flow-rate detection determination step S3.

The count start step S5 may include a step of starting a count of preheating time for preheating time learning.

After the count start step S5 is performed, the flow-rate storage step S6 may be performed.

The flow-rate storage step S6 may include a step of storing the detected flow rate of the hot water circulating along the hot water circulation path during the preheating operation in the first flow-rate detection determination step S3.

The second flow-rate detection determination step S7 may include a step of determining whether the hot water circulates along the hot water circulation path during the preheating operation.

That is, the second flow-rate detection determination step S7 may include a step of determining whether the hot water circulation path is consistently formed by determining whether the flow rate of the hot water circulation path is detected after the circulation pump 30 is operated during the preheating operation.

When it is determined in the second flow-rate detection determination step S7 that the flow rate is not detected (N), the second time elapsing determination step S8 may be performed.

Meanwhile, when it is determined in the second flow-rate detection determination step S7 that the flow rate is detected, the flow-rate determination step S12 may be performed.

The second time elapsing determination step S8 may include a step of determining whether the flow rate of the hot water circulation path in the preheating operation is detected for a preset period of time (e.g., 30 seconds).

When it is determined in the second time elapsing determination step S8 that the time during which the flow rate is not detected exceeds the preset period of time (e.g., 30 seconds) (Y), the count stop step S9 may be performed.

Meanwhile, it is determined in the second time elapsing determination step S8 that the flow rate is detected for the preset period of time (N), the flow-rate determination step S12 may be performed through the second flow-rate detection determination step S7.

The count stop step S9 may include a step of stopping the count that started in the count start step S5. When the count is stopped in the count stop step S9, the count values counted from the count start step S5 may be stored.

The moving average calculation step S10 may include a step of calculating the average of the stored count values (e.g., a preset number of count values recently stored).

The average value of the count values that is calculated in the moving average calculation step S10 may be used as the preheating operation time of the hot water supply system according to one embodiment of the present disclosure.

The circulation pump stop step S11 may be performed after the moving average calculation step S10.

The circulation pump stop step S11 may be a step of stopping the operation of the circulation pump 30. The circulation pump stop step S11 may be a step that indicates that the preheating operation of the hot water supply system according to one embodiment of the present disclosure is terminated.

The flow-rate determination step S12 may include a step of determining whether the flow rate (the current flow rate) of the hot water circulating along the hot water circulation path during the preheating operation exceeds a preset flow rate (e.g., the flow rate stored in the flow-rate storage step S6+an allowable error).

When it is determined in the flow-rate determination step S12 that the detected current flow rate does not exceed the preset flow rate (N), the second flow-rate detection determination step S7 may be preformed.

Meanwhile, when it is determined in the flow-rate determination step S12 that the detected current flow rate exceeds the preset flow rate (Y), the count initialization step S13 may be performed.

The count initialization step S13 may include a step of initializing the count value that started in the count start step S5.

When the current flow rate exceeds the preset flow rate in the flow-rate determination step S12, it is determined that the user uses the hot water, and the count value that started in the count start step S5 may be initialized.

The circulation pump stop step S11 may be performed after the count initialization step S13.

As described above, the preheating time learning method using the hot water supply system according to one embodiment of the present disclosure may start the count when the circulation pump operates and the flow rate of the hot water circulation path is detected after the request for preheating is identified. The preheating time learning method may stop the count and may store the counted count value when the flow rate of the hot water circulation path is not detected.

Thereafter, the preheating time learning method using the hot water supply system according to one embodiment of the present disclosure may learn the preheating time by calculating the moving average value of the stored count values.

The hot water supply system and the preheating time learning method using the same according to one embodiment of the present disclosure may perform the preheating operation control to raise the temperature of the hot water circulation path to the valve operation temperature of the normally operating hot water circulation valve (e.g., in the preheating operation, the hot water circulation valve connects the hot water pipe 5 and the direct water pipe 6 at a temperature lower than the valve operation temperature and separates the hot water pipe 5 and the direct water pipe 6 at a temperature higher than the valve operation temperature) and may learn the preheating time.

The hot water supply system and the malfunction determination method using the same according to one embodiment of the present disclosure may determine that the hot water circulation valve 20 fails and may notify the user of the failure (error) in the hot water circulation valve when the flow rate is detected even after the learned preheating time elapses.

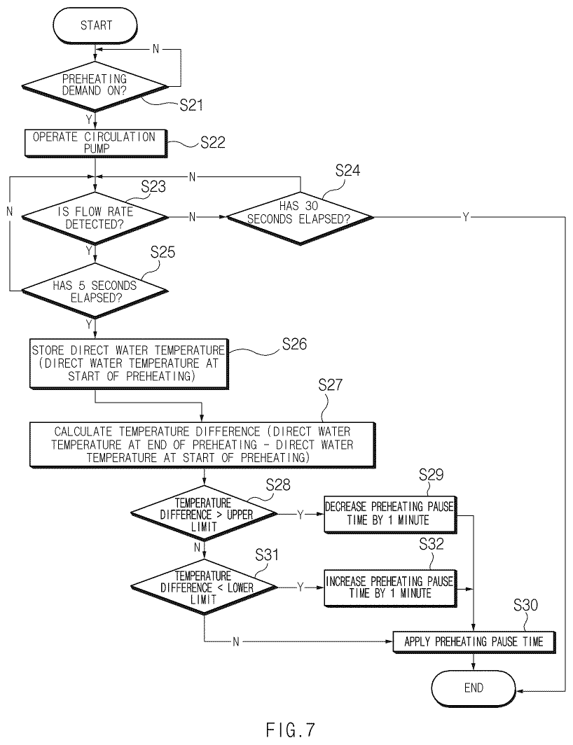

FIG. 7 is a flowchart for explaining an operation of the hot water supply system according to one embodiment of the present disclosure.

In particular, FIG. 7 is for explaining a preheating pause time learning method and a malfunction determination method using the hot water supply system according to one embodiment of the present disclosure.

Referring to FIG. 7, the preheating pause time learning method using the hot water supply system according to one embodiment of the present disclosure may include a preheating request identification step S21, a circulation pump operation step S22, a flow-rate detection determination step S23, a time elapsing step S24, a time elapsing determination step S25, a temperature storage step S26, a temperature difference calculation step S27, a first comparison step S28, a preheating pause time decrease step S29, a preheating pause time application step S30, a second comparison step S31, and a preheating pause time increase step S32.

The preheating request identification step S21 may include a step of determining whether preheating is requested.

When it is determined in the preheating request identification step S21 that the preheating is requested (Y), the circulation pump operation step S22 may be performed.

Meanwhile, when it is determined in the preheating request identification step S21 that the preheating is not requested (N), the preheating request identification step S21 may be performed until a request for preheating is identified.

The circulation pump operation step S22 may include a step of operating the circulation pump 30. The heated water (hot water) from the boiler 10 may be circulated to the boiler 10 through the hot water pipe 5, the hot water circulation valve 20, and the direct water pipe 6. That is, when it is determined that the preheating is requested, the boiler 10 may heat water and may output the heated water to the hot water pipe 10, and the heated water (hot water) may be provided to the direct water pipe 6 through the hot water pipe 10 and the hot water circulation valve 20 and may be circulated back to the boiler 10 through the direct water pipe 6. In the preheating operation control, the hot water may be circulated along the circulation path constituted by the hot water pipe 5, the hot water circulation valve 20, and the direct water pipe 6. Since the temperature of the hot water reaching the hot water circulation valve 20 from the hot water pipe 5 is lower than or equal to the valve operation temperature immediately after the circulation pump operation step S22 is performed, the hot water circulation valve 20 may be in a state of physically connecting the hot water pipe 5 and the direct water pipe 6.

The flow-rate detection determination step S23 may include a step of detecting and identifying the flow rate of the hot water circulation path in the preheating operation that includes the hot water pipe 5, the hot water circulation valve 20, and the direct water pipe 6.

When it is determined in the flow-rate detection determination step S23 that the flow rate of the hot water circulation path in the preheating operation is not detected and the hot water circulation path is not formed (N), the time elapsing step S24 may be performed.

Meanwhile, when it is determined in the flow-rate detection determination step S23 that the flow rate of the hot water circulation path in the preheating operation is detected and the hot water circulation path is formed (Y), the time elapsing determination step S25 may be performed.

The time elapsing step S24 may include a step of performing the flow rate detection determination step S23 again after a preset period of time elapses (e.g., 30 seconds).

The time elapsing determination step S25 may include a step of determining whether the circulation pump 30 is operated during the preheating operation and the flow rate of the hot water circulation path is consistently detected for a preset period of time (e.g., 5 seconds).

For example, when it is determined in the time elapsing determination step S25 that the circulation pump 30 is operated during the preheating operation and the flow rate of the hot water circulation path is not consistently detected for the preset period of time (e.g., 5 seconds) (N), the flow-rate detection determination step S23 may be performed again.

Meanwhile, when it is determined in the time elapsing determination step S25 that the circulation pump 30 is operated during the preheating operation and the flow rate of the hot water circulation path is consistently detected for the preset period of time (e.g., 5 seconds) (Y), the temperature storage step S25 may be performed.

The temperature storage step S26 may include a step of storing the temperature provided from the temperature sensor 13. When the temperature sensor 13 is disposed in the direct water pipe 6, the temperature storage step S26 may be a step of storing the water temperature when the preheating operation starts, the circulation pump 30 operates, and the water circulating along the hot water circulation path for a preset period of time (5 seconds) is circulated back to the boiler 10 through the direct water pipe 6.

The temperature difference calculation step S27 may include a step of calculating the difference between the water temperature provided from the temperature sensor 13 at the time point when the preheating operation time ends and the water temperature stored in the temperature storage step S26, that is, the water temperature at the time point when the preheating operation time starts (at the time point when a preset period of time elapses).

The first comparison step S28 may include a step of comparing the temperature difference calculated in the temperature difference calculation step S27 and the upper limit of a preset range.

For example, when it is determined in the first comparison step S28 that the calculated temperature difference exceeds the upper limit (Y), the preheating pause time decrease step S29 may be performed.

Meanwhile, when it is determined in the first comparison step S28 that the calculated temperature difference does not exceed the upper limit (N), the second comparison step S31 may be performed.

The preheating pause time decrease step S29 may include a step of deceasing the preheating pause time by a preset time (e.g., one minute).

The second comparison step S31 may include a step of comparing the temperature difference calculated in the temperature difference calculation step S27 and the lower limit of the preset range.

For example, when it is determined in the second comparison step S31 that the calculated temperature difference is less than the lower limit (Y), the preheating pause time increase step S32 may be performed.

Meanwhile, when it is determined in the second comparison step S31 that the calculated temperature difference is not less than the lower limit (N), the preheating pause time application step S30 may be performed.

The preheating pause time application step S30 may be a step performed when the temperature difference calculated in the preheating pause time decrease step S29, the preheating pause time increase step S32, or the second comparison step S31 is not less than the lower limit.

For example, the preheating pause time application step S30 performed after the preheating pause time decrease step S29 may include a step of determining the start timing of the preheating operation time by applying the preheating pause time decreased in the preheating pause time decrease step S29 and a step of generating preheating operation time information including the start timing of the preheating operation time.

In addition, the preheating pause time application step S30 performed after the preheating pause time increase step S32 may include a step of determining the start timing of the preheating operation time by applying the preheating pause time increased in the preheating pause time increase step S32 and a step of generating preheating operation time information including the start timing of the preheating operation time.

The preheating pause time application step S30 performed when the temperature difference calculated in the second comparison step S31 is not less than the lower limit may include a step of determining the start timing of the preheating operation time by maintaining the previous preheating pause time and a step of generating preheating operation time information including the start timing of the preheating operation time.

Although the present disclosure has been described above with reference to the accompanying drawings, the present disclosure is not limited by the embodiments of the present disclosure and the drawings, and various modifications and alterations may be made by those skilled in the art without departing from the spirit and scope of the present disclosure. In addition, although effects depending on the components of the present disclosure are not explicitly described in the description of the embodiments of the present disclosure, it is natural that effects predictable by the corresponding components should also be recognized.

1. A hot water supply system comprising:
a boiler configured to heat water supplied from a direct water pipe and provide the heated water to a hot water pipe; and
a hot water circulation valve configured to connect or separate the hot water pipe and the direct water pipe based on a valve operation temperature,
wherein the hot water supply system performs at least one of an operation of learning preheating time based on a flow rate of water circulating through the hot water pipe, the hot water circulation valve, the direct water pipe, and the boiler during a preheating operation, an operation of changing preheating pause time based on a difference between a temperature of the water circulating through the hot water pipe, the hot water circulation valve, the direct water pipe, and the boiler at the end of the preheating operation and a temperature of the circulating water at the start of the preheating operation, or a combination of the operations.

2. The hot water supply system of claim 1, further comprising:
a hot water supply management device configured to perform at least one of an operation of learning the preheating time based on the flow rate of the water circulating through the hot water pipe, the hot water circulation valve, the direct water pipe, and the boiler during the preheating operation and determining a malfunction of the hot water circulation valve based on the learned preheating time, an operation of calculating a difference between a temperature of water in the direct water pipe at the end of the preheating operation and a temperature of the water in the direct water pipe at the start of the preheating operation, changing the preheating pause time by comparing the calculated temperature difference with a preset range, and determining a failure in the hot water circulation valve based on a flow rate in the direct water pipe during the preheating operation to which the changed preheating pause time is applied, or a combination of the operations.

3. The hot water supply system of claim 2, wherein the hot water supply management device includes:
a flow sensor configured to sense the flow rate of the water circulating through the hot water pipe, the hot water circulation valve, the direct water pipe, and the boiler during the preheating operation; and
a malfunction determination device configured to detect and determine a malfunction of the hot water circulation valve based on preheating operation time information and flow rate information of the flow sensor.

4. The hot water supply system of claim 3, wherein the hot water supply management device further includes:
a preheating time learning device configured to learn the preheating time based on the valve operation temperature, preheating stop temperature, and the flow rate information; and
a controller configured to generate the preheating operation time information based on the learned preheating time and provide an error notification depending on the detection of the malfunction by the malfunction determination device.

5. The hot water supply system of claim 4, wherein the preheating time learning device learns the preheating time based on the flow rate information of the flow sensor when the preheating stop temperature is higher than the valve operation temperature.

6. The hot water supply system of claim 5, wherein the preheating time learning device starts a count of the preheating time when the flow rate is detected based on the flow rate information during the preheating operation, stops the count when the flow rate is not detected, and stores count values when the count is stopped.

7. The hot water supply system of claim 6, wherein the preheating time learning device calculates a moving average of the stored count values and learns the calculated value as the preheating time.

8. The hot water supply system of claim 6, wherein the preheating time learning device initializes the started count when a current flow rate based on the flow rate information exceeds a preset flow rate after the count of the preheating time starts during the preheating operation.

9. The hot water supply system of claim 4, wherein the malfunction determination device determines that the preheating operation ends, based on the preheating operation time information and determines a malfunction of the hot water circulation valve when a current flow rate is detected based on the flow rate information even after the preheating operation ends and a preset period of time elapses.

10. The hot water supply system of claim 3, wherein the hot water supply management device further includes:
a temperature sensor configured to sense the temperature of the water circulating through the hot water pipe, the hot water circulation valve, the direct water pipe, and the boiler;
a preheating pause time learning device configured to learn the preheating pause time based on temperature information of the temperature sensor; and
a controller configured to generate the preheating operation time information based on the learned preheating pause time and provide an error notification depending on the detection of the malfunction by the malfunction determination device.

11. The hot water supply system of claim 10, wherein the preheating pause time learning device calculates the difference between the temperature of the water in the direct water pipe at the end of the preheating operation and the temperature of the water in the direct water pipe at the start of the preheating operation and decreases the preheating pause time by a preset time when the calculated temperature difference exceeds an upper limit of the preset range.

12. The hot water supply system of claim 10, wherein the preheating pause time learning device calculates the difference between the temperature of the water in the direct water pipe at the end of the preheating operation and the temperature of the water in the direct water pipe at the start of the preheating operation and increases the preheating pause time by a preset time when the calculated temperature difference is less than a lower limit of the preset range.

13. The hot water supply system of claim 10, wherein the preheating pause time learning device calculates the difference between the temperature of the water in the direct water pipe at the end of the preheating operation and the temperature of the water in the direct water pipe at the start of the preheating operation and maintains the preheating pause time when the calculated temperature difference is within the preset range.

14. The hot water supply system of claim 12, wherein the malfunction determination device determines that the preheating operation starts, based on the preheating operation time information and determines a malfunction of the hot water circulation valve when a current flow rate is detected based on the flow rate information even after the preheating operation ends and a preset period of time elapses.

15. A method for operating a hot water supply system, the method comprising:
identifying a request for preheating:
operating a circulation pump;
detecting a flow rate of a hot water circulation path;
starting a count and storing the detected flow rate when the circulation pump is operated and the flow rate of the hot water circulation path is detected;
stopping the started count and storing count values when the flow rate of the hot water circulation path is not detected; and
calculating a moving average of the stored count values and learning the calculated moving average as preheating time,
wherein the hot water circulation path is a path along which heated water from a boiler is circulated back to the boiler through a hot water pipe, a hot water circulation valve, and a direct water pipe.

16. The method of claim 15, further comprising:
determining that a user uses hot water and initializing the started count when a currently-detected flow rate exceeds a preset flow rate.

17. The method of claim 15, further comprising:
notifying a user of a failure in the hot water circulation valve when the flow rate of the hot water circulation path is detected even after the learned preheating time and a preset period of time elapse.

18. A method for operating a hot water supply system, the method comprising:
identifying a request for preheating:
operating a circulation pump;
detecting and storing a temperature of water in a hot water circulation path;
calculating a difference between a temperature of water in the hot water circulation path at the end of a preheating operation and a temperature of water in the hot water circulation path at the start of the preheating operation; and
changing preheating pause time by comparing the calculated water temperature difference with a preset range,
wherein the hot water circulation path is a path along which heated water from a boiler is circulated back to the boiler through a hot water pipe, a hot water circulation valve, and a direct water pipe.

19. The method of claim 18, wherein the changing of the preheating pause time includes:
decreasing the preheating pause time by a preset time when the calculated water temperature difference exceeds an upper limit of the preset range;
increasing the preheating pause time by the preset time when the calculated water temperature difference is less than a lower limit of the preset range; and
maintaining the preheating pause time when the calculated water temperature difference is within the preset range.

20. The method of claim 18, further comprising:
determining a failure in the hot water circulation valve when a flow rate of the hot water circulation path is not detected even after a preset period of time elapses after start timing of preheating operation time to which the changed preheating pause time is applied.
